(19) United States
(12) Patent Application Publication
(10) Pub. No.: US 2014/0056708 A1
(43) Pub. Date: Feb. 27, 2014

(54) SYSTEM FOR USING WIND POWER

(71) Applicant: Rainer Samson, Munster (DE)

(72) Inventor: Rainer Samson, Munster (DE)

(21) Appl. No.: 14/002,723

(22) PCT Filed: Feb. 23, 2012
(86) PCT No.: PCT/DE2012/000182

§ 371 Date: Oct. 30, 2013

(30) Foreign Application Priority Data
Mar. 2, 2011 (DE) 20 2011 003 456.9

(51) Int. Cl. F03D 11/04; F03D 3/06

(52) U.S. Cl. CPC F03D 11/04; F03D 3/06
USPC 416/170 R

(57) ABSTRACT

For a system for using wind power having at least one rotor, wherein the rotor has a rotor shaft having a vertically arranged rotational axis and rotor blades offset from each other by the same angle in the rotational direction of the rotor shaft are arranged on the rotor shaft, each rotor is accommodated in a frame of a wind power module, the rotor shaft is supported in receptacles of the frame in such a way that the rotor shaft can be rotated at both ends of the rotor shaft, and individual rotors of several wind power modules can be coupled to each other in a force-closed manner by means of the receptacles for the rotor shafts. Said system can be used flexibly and has a high efficiency.

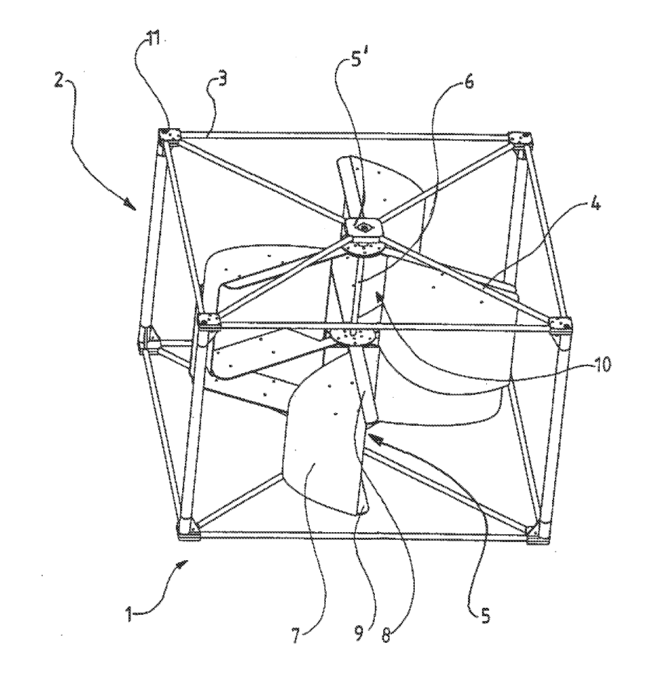

The invention relates to a system for using wind power comprising at least one rotor, wherein the rotor has a rotor shaft having a vertically arranged axis of rotation and rotor blades offset from each other by the same angle in the direction of rotation of the rotor shaft are arranged on the rotor shaft.

Wind power systems having a vertically arranged axis of rotation usually have a lower efficiency compared with those having a horizontal axis of rotation of the rotor lying in the wind direction, which so far conflicts with economic operation. This is particularly the case when the rotors are configured as resistance rotors. The low efficiency is frequently caused by the fact that the wind always impinges upon the rotor blades rotating with the wind direction and contrary to the wind direction and only flows off inadequately on the rotor blades rotating contrary to the wind direction. Attempts are therefore made inter alia to divert or deflect the air flow with housings arranged partially around the rotors but the disadvantage here is that the wind can only be intercepted from one direction. Furthermore, wind power systems having a horizontally arranged axis of rotation and also wind power systems having a vertically arranged axis of rotations usually cannot be extended after they have been erected. Adaptations to a changed performance profile for example are not possible without exchanging essential parts, which usually requires dismantling of the entire wind power system.

It is the object of the invention to provide a system for using wind power which can be used flexibly and which can be extended and which has a higher efficiency compared with previous resistance rotors having a vertical axis of rotation.

The solution of this object is accomplished with a system according to claim 1. Further developments and advantageous configurations of the system are given in the subclaims 2 to 10.

In a system for using wind power comprising at least one rotor, wherein the rotor has a rotor shaft having a vertically arranged axis of rotation and rotor blades offset from each other by the same angle in the direction of rotation of the rotor shaft are arranged on the rotor shaft, it is provided according to the invention that each rotor is accommodated in a frame of a wind power module, that the rotor shaft is rotatably mounted with both its ends in receptacles of the frame and that individual rotors of several wind power modules can be non-positively coupled to one another by means of the receptacles for the rotor shafts.

The receptacles in which the rotor shafts are mounted and by which means two rotor shafts can be non-positively connected to one another enable two or more wind power modules to be placed on a common generator. Depending on the number of wind power modules and the overall torque produced, the required power of the generator can then be determined. The frame in which the rotors are accommodated gives a system composed of several wind power modules the necessary stability. To this end the frames of the wind power modules advantageously have mounting means by means of which the wind power modules can be connected and combined in a modular fashion to form a system.

Since the individual wind power modules can be combined to form a system, the size of the system for using wind power can be adapted flexibly to the power required or the maximum possible power at the site of the system. Subsequent extensions are possible by attaching additional wind power modules and a generator, which can be exchanged if required, without major expenditure.

In order to ensure operation of the system regardless of the inflow direction of the wind, at least three rotor blades are required. These are preferably to be arranged in a plane perpendicular to the axis of rotation of the rotor at an angle of 120° with the result that particularly compact dimensions of a wind power module are achieved. The space available around the circumference of the rotor shaft is therefore optimally utilised. In order to obtain a more uniform and higher torque, a total of more than three rotor blades can be provided which can then be arranged at respectively smaller angular spacings from one another. Advantageously six rotor blades are arranged in at least two planes perpendicular to the axis of rotation of the rotor, where the angular spacing of the rotor blades from one another in one plane is 120° and the rotor blades of a first plane are offset with respect to a second plane by 60° with a total of two planes in a wind power module.

A further advantage of many rotor blades is that imbalances that may occur during operation of the apparatus are reduced and therefore direction-dependent changing loads acting on the rotor are avoided. At the same time, it is achieved that a torque produced by turning of the rotor is subject to fewer fluctuations.

According to a further development, it is provided that the rotor blades are arranged radially at a distance from the rotor shaft, where at least one wind passage is formed between the rotor blades and the rotor shaft. The wind passages have the result that during operation of the system the resistance to the wind from the rotor blades rotating contrary to the wind direction, having wind flowing onto the rear side, is reduced compared with rotor blades resting on the rotor shaft. The wind impinging upon the rotor blades having wind flowing onto the rear side can then flow off more favourably on both sides, that is both on the side facing the rotor shaft and on the side facing away from the rotor shaft. Since the wind impinging upon the rotor blades rotating in the wind direction is “intercepted” unchanged by these rotor blades, the rotor according to the invention has an overall improved flow profile at the rotor blades with a particularly favourable ratio of pressure to counterpressure. The efficiency of the system is particularly favourable as a result.

In order to ensure that the wind passages are sufficiently dimensioned, it is provided that the surface areas of the wind passages between the rotor blades and the rotor shaft are in each case at least one sixth of the surfaces areas of the rotor blades, in particular in each case at least a quarter of the surface area of the rotor blades, in particular in each case at least half the surface area of the rotor blades. These dimensions ensure that the air deflected from the rotor blades having wind flowing onto the rear side can be diverted in an optimal manner and without accumulations of air by the rotor blades, where the surface area at least required is dependent on the configuration of the rotor blades. With appropriately specially shaped rotor blades, the surface area of the wind passages can also be only one seventh to one eighth of the surface area of the rotor blades.

In vertical extension, the wind passages formed between the rotor blades and the rotor shaft are advantageously delimited in each case by a supporting arm. These supporting arms are advantageously connected to the rotor shaft and form a supporting frame for the rotor blades, where the rotor blades are held between the supporting arms in the supporting frame. The surface areas of the wind passage are therefore as large as possible. In addition, air turbulence is avoided as a result of struts of the supporting frame. The rotor blade held on the respective supporting arm is at the same time optimally fixed, a simply designed and light supporting frame being provided.

A strongly direction-dependent changing loading of the rotor or individual supporting arms can be effectively counteracted whereby all the supporting arms arranged in a rotational plane of a wind power module are configured as a one-piece component. In order to prevent icing in appropriate weather, the rotor blades and/or supporting arms can also be designed to be heatable.

In particular, the counterpressure acting on the rotor blades having wind flowing onto the rear side during operation contrary to the wind direction can be minimised by a fluidically favourable configuration of the rotor blades. It can therefore be provided that the rotor blades are configured as depressions with outwardly curved blade backs in the direction of rotation of the axis of rotation of the rotor. In one embodiment, the depression is semi-cylindrically shaped, for example, where the rotor blades are fastened with surface sections parallel to one another to the supporting arms of the supporting frame. During operation of the system the wind presses into the depressions of the rotor blades which are open towards the wind. The wind flowing into the depressions is “intercepted” and builds up pressure therein, which is converted into a rotational movement of the rotor. The wind is guided in a simple manner around the curved blade backs of the rotor blades contrary to the wind. In this case, the pressure in the respective depressions exceeds the counterpressure acting on the curved outer blade backs of the rotor blades.

In an alternative embodiment, the rotor blades can also have the shape of a pyramid with convexly curved blade back surfaces, wherein the base area of the pyramids is configured as an open recess or a depression. This shape is very close to the advantageous flow behaviour at a sphere so that the wind impinging upon the convexly curved outer blade back surfaces can flow off from these in an optimal manner. At the same time, the base area of the pyramids creates a large inflow surface with which as much wind as possible can be “intercepted” to produce pressure to propel the rotor, particularly if the base area is configured to be rectangular.

The torque which can be produced with the system can be increased by an optimised wind load distribution on the rotor blades. To this end it is provided that the rotor blades have an asymmetric curvature with a wind load focus arranged offset towards the outside from the centre thereof. The wind load focus is dependent on the shape of the rotor blade and when a depression is formed, usually on the deepest area of the depression. Since the torque increases with the distance of the rotor shaft, the deepest point of the depressions of the rotor blades should be arranged at the greatest possible distance from the rotor shaft. This large distance is achieved with the asymmetric curvature without increasing the dimensions of the rotor itself.

A high stability of a system erected from wind power modules can advantageously be achieved whereby the frame of a wind power module has a rectangular shape with a square standing surface, wherein the edges of the standing surface are longer than the edges arranged perpendicular to the standing surface. The rectangular shape enables wind power modules to be arranged both on one another and next to one another in a particularly simple manner. An overall low height of the wind power modules in relation to the width is particularly advantageous when several wind power modules are arranged above one another so that the required stability can be ensured even with several wind power modules above one another without additional struts and/or securing means. In this case, the rotor with the rotor blades has a span which is smaller than the length of the edges of the square standing surface of the frame.

The receptacles for the rotor shaft of a wind power module are advantageously each arranged centrally in two outer surfaces of the wind power module extending parallel to one another. These outer surfaces are the standing surface and a top surface of the wind power module, where standing surface and top surface of two wind power modules arranged on one another abut against one another. A non-positive connection of the two rotor shafts is then ensured by means of the two receptacles in the standing surface of one wind power module and the top surface of the other wind power module. The number of wind power modules arranged one above the other and driving a common generator can therefore be adapted to the particular generator.

Mounting plates which can be connected to one another can be provided for the mutual fixing of the wind power modules, which can be arranged in particular in the corners of the rectangular frame of a wind power module. The mounting plates are advantageously to be arranged both on the standing and top surface and also at the sides of the wind power modules.

The single FIGURE of the drawings shows a perspective view of a wind power module 1. This wind power module 1 has a rectangular frame 2. The frame 2 consists of frame rods 3 arranged at right angles to one another along the edges of the frame 2 and crossing diagonal struts 4 in two side surfaces of the rectangular frame 2 arranged parallel to one another. The side surfaces with the diagonal struts 4 are configured as standing surface and as top surface of the rectangular frame 2 and each have square surface areas.

Respectively one receptacle 5 or 5′ is arranged at the points of intersection of the diagonal struts 4, where a rotor shaft 6 having a vertically arranged axis of rotation is mounted between the receptacles 5, 5′. This rotor shaft 6 can be connected non-positively by means of the receptacles 5, 5′ to the rotor shafts 6 of further wind power modules 1, where respectively one receptacle 5 and one receptacle 5′ can be coupled to one another.

Rotor blades 7 are arranged on the rotor shaft 6 in two planes perpendicular to the axis of rotation of the rotor shaft 6, where each of the plane has three rotor blades 7 arranged offset to one another by 120° in each case. The rotor blades 7 are each held on the rotor shaft 6 by means of a supporting frame comprising an upper supporting arm 8 and a lower supporting arm 9, where respectively 6 supporting arms 8 and 6 supporting arms 9 are arranged perpendicular to the rotor shaft 6.

The rotor blades 7 are configured as asymmetric depressions with outwardly curved blade backs in the direction of rotation of the rotor shaft 6. Each of the rotor blades 7 additionally has two mutually opposite surface sections arranged inclined to one another at an angle of about 20° , which define the blade backs at curved sections and to which the supporting arms 8, 9 are fastened in each case. Together with the blade back a wind inflow surface of the rotor blades is therefore formed between this and the two surface segments, where the surface segments are arranged tapering towards one another towards the blade back. Respectively one wind passage 10 is formed between the rotor shaft 6 and the rotor blades 7, which is additionally delimited by the respective supporting arms 8, 9.

In order to join several wind power module 1 in a modular fashion to one another, mounting plates 11 are arranged at corners of the standing surface with the receptacle 5 and the top surface with the receptacle 5′ of a wind power module 1, which can be joined to the mounting plates 11 of another wind power module 1. When connecting two wind power module 1, the receptacles 5 and 5′ of adjacent top and standing surface intermesh so that the rotor shafts 6 held in the receptacles 5, 5′ are non-positively coupled to one another. For power generation the rotor shaft 6 of one of the wind power modules 1 can be coupled to a generator via the receptacles 5 or 5′.

During operation of the system wind presses into the recesses of the cavities of the rotor blades 7 which are open towards the wind and the rotor shaft 6 is set in rotation. The wind impinging upon he curvatures of the rotor blades 7 rotating contrary to the wind direction is deflected to the rotor shaft 6 and outwards on the curve and flows off at the side of the rotor shaft 6 via the respective wind passage 10 in a simple manner.

1. System for using wind power comprising at least one rotor, wherein the rotor has a rotor shaft having a vertically arranged axis of rotation and rotor blades offset from each other by the same angle in the direction of rotation of the rotor shaft are arranged on the rotor shaft, characterised in that each rotor is accommodated in a frame (2) of a wind power module (1), that the rotor shaft (6) is rotatably mounted with both its ends in receptacles (5, 5′) of the frame (2) and that individual rotors of several wind power modules (1) can be non-positively coupled to one another by means of the receptacles (5, 5′) for the rotor shafts (6).

2. The system according to claim 1, characterised in that the rotor blades (7) of a wind power module (1) are arranged in at least one rotational plane, in particular in at least two rotational planes, perpendicular to the axis of rotation of the rotor.

3. The system according to any one of claim 1 or 2, characterised in that the rotor blades (7) are arranged radially at a distance from the rotor shaft (6), wherein at least one wind passage (10) is formed between the rotor blades (7) and the rotor shaft (6).

4. The system according to claim 4, characterised in that the surface areas of the wind passages (10) between the rotor blades (7) and the rotor shaft (6) are at least one sixth of the surfaces areas of the rotor blades (7).

5. The system according to any one of claims 1 to 4, characterised in that each of the rotor blades (7) is held on a supporting frame comprising two supporting arms (8, 9) connected to the rotor shaft (6).

6. The system according to claim 5, characterised in that all the supporting arms (8, 9) arranged in a rotational plane of a wind power module (1) are configured as a one-piece component.

7. The system according to any one of claims 1 to 6, characterised in that the rotor blades (7) are configured as depressions with outwardly curved blade backs in the direction of rotation of the axis of rotation of the rotor.

8. The system according to any one of claims 1 to 7, characterised in that the rotor blades (7) have the shape of a pyramid with convexly curved blade back surfaces, wherein the base area of the pyramids is configured as an open recess (8).

9. The system according to any one of claims 1 to 8, characterised in that the rotor blades (7) have an asymmetric curvature with a wind load focus arranged offset towards the outside from the centre thereof.

10. The system according to any one of claims 1 to 9, characterised in that the frame (2) of a wind power module (1) has a rectangular shape with a square standing surface, wherein the edges of the standing surface are longer than the edges arranged perpendicular to the standing surface.

11. The system according to claim 10, characterised in that the rotor with the rotor blades (7) has a span which is smaller than the length of the edges of the square standing surface of the frame (2).

12. The system according to any one of claims 1 to 11, characterised in that the receptacles (5, 5′) for the rotor shaft (6) of a wind power module (1) are each arranged centrally in two outer surfaces of the wind power module (1) extending parallel to one another.
